(19) United States
(12) Patent Application Publication
(10) Pub. No.: US 2016/0254691 A1
(43) Pub. Date: Sep. 1, 2016

(54) WIRELESS CHARGING SYSTEM AND METHOD OF CONTROLLING PERMISSION FOR CHARGING IN WIRELESS CHARGING SYSTEM

(71) Applicant: ELECTRONICS AND TELECOMMUNICATIONS RESEARCH INSTITUTE, Daejeon (KR)

(72) Inventors: Han-Seung KOO, Daejeon (KR); Sung-Hei KIM, Daejeon (KR); Ju-Young PARK, Daejeon (KR)

(73) Assignee: ELECTRONICS AND TELECOMMUNICATIONS RESEARCH INSTITUTE, Daejeon (KR)

(21) Appl. No.: 14/976,875

(22) Filed: Dec. 21, 2015

(30) Foreign Application Priority Data
Feb. 27, 2015 (KR) 10-2015-0028079

(51) Int. Cl. H02J 7/02; H04W 12/06; H02J 50/80; H02J 7/04

(52) U.S. Cl. CPC H02J 7/025; H02J 7/042; H04W 12/06; H02J 50/80

(57) ABSTRACT

A wireless charging system and a method of controlling permission for charging in the wireless charging system are provided herein. The wireless charging system includes a power transmitting unit and an authentication server. The power transmitting unit transmits a power receiving unit (PRU) control message to a power receiving unit, receives PRU dynamic parameter characteristics generated by the power receiving unit based on an authentication number input by the user of the power receiving unit, and wirelessly supplies charging power to the power receiving unit based on the input result of authentication. The authentication server authenticates the authentication number input by the user and included in the PRU dynamic parameter characteristics provided by the power transmitting unit, and transmits the result of the authentication to the power transmitting unit.

### CROSS-REFERENCE TO RELATED APPLICATION

This application claims the benefit of Korean Patent Application No. 10-2015-0028079, filed Feb. 27, 2015, which is hereby incorporated by reference herein in its entirety.

### BACKGROUND

1. Technical Field

The present disclosure relates generally to a wireless charging system and a method of controlling permission for charging in the wireless charging system and, more particularly, to a system and method that are capable of permitting or denying wireless charging depending on whether a power provider has approved the wireless charging, based on a wireless charging technology that is being developed by the Alliance for Wireless Power (A4WP), which is a wireless charging technology standardization organization.

2. Description of the Related Art

The current A4WP standard defines a wireless charging technology via a Power Transmitting Unit (PTU) for wirelessly supplying charging power and a Power Receiving Unit (PRU) for wirelessly receiving charging power.

According to the current standard, when any PRU is connected to a PTU, it can receive wireless charging service regardless of whether a power provider has approved it as long as a technical problem, such as excessive voltage or excessive heating, does not occur.

That is, the A4WP standard that is currently being developed does not include a technology that is capable of performing control when it is necessary to supply power to only a permitted PRU via a user's own PTU.

For example, the A4WP standard cannot support the case where the owner of a coffee shop wants to provide wireless charging service only to the customers of the coffee shop via Power Transmitting Units (PTUs) installed on respective tables.

Technologies related to the present invention include Korean Patent Application Publication 2012-0120692 entitled “Apparatus and System for Providing Wireless Charging Service,” U.S. Patent Application Publication No. 2011-0147468 entitled “RFID Tag,” and U.S. Patent Application Publication No. 2013-0280557 entitled “Ultrasonic Rechargeable Battery Module and Ultrasonic Rechargeable Battery Apparatus of Polyhedral Structure Including the Same.”

### SUMMARY

At least some embodiments of the present invention are directed to the provision of a wireless charging system and a method of controlling permission for charging in the wireless charging system, which is capable of permitting or denying the wireless charging of a PRU through the control of the approval of a power provider based on an A4WP technology.

In accordance with an aspect of the present invention, there is provided a method of controlling permission for charging in a wireless charging system, including: transmitting, by a power transmitting unit, a Power Receiving Unit (PRU) control message to a power receiving unit; receiving, by the power transmitting unit, PRU dynamic parameter characteristics generated by the power receiving unit based on an authentication number input by the user of the power receiving unit; transmitting, by the power transmitting unit, the authentication number, input by the user and included in the PRU dynamic parameter characteristics, to an authentication server; authenticating, by the authentication server, the authentication number input by the user; and wirelessly supplying, by the power transmitting unit, charging power to the power receiving unit based on the result of the authentication of the authentication server.

The PRU control message may include an “Authentication” field and a “Permission” field.

The “Authentication” field, when the value of a request authentication bit within the “Authentication” field is “1,” may indicate that an authentication number-based authentication procedure is required.

The “Permission” field may contain bits indicating that since authentication has not been successfully performed, charging is not permitted immediately but will be permitted only when authentication is successfully performed later.

Transmitting the PRU control message may be performed as an A4WP connection is established between the power transmitting unit and the power receiving unit.

The PRU dynamic parameter characteristics may include an “Authentication Number” field indicative of the authentication number input by the user, and the “Authentication Number” field may contain a value ranging from 0 to 65535.

Wirelessly supplying the charging power to the power receiving unit may include wirelessly supplying the charging power to the power receiving unit only if the authentication server determines that the authentication number input by the user is a valid authentication number.

The method may further include, between authenticating the authentication number input by the user and wirelessly supplying the charging power to the power receiving unit, transmitting, by the authentication server, the result of the authentication to the power transmitting unit.

The result of the authentication may additionally include charging time.

Wirelessly supplying the charging power to the power receiving unit may include wirelessly supplying the charging power only for the charging time.

In accordance with another aspect of the present invention, there is provided a wireless charging system, including: a power transmitting unit configured to transmit a power receiving unit (PRU) control message to a power receiving unit, to receive PRU dynamic parameter characteristics generated by the power receiving unit based on an authentication number input by the user of the power receiving unit, and to wirelessly supply charging power to the power receiving unit based on the input result of authentication; and an authentication server configured to authenticate the authentication number input by the user and included in the PRU dynamic parameter characteristics provided by the power transmitting unit, and to transmit the result of the authentication to the power transmitting unit.

The power transmitting unit may transmit the PRU control message as an A4WP connection is established between the power transmitting unit and the power receiving unit.

The power transmitting unit may wirelessly supply the charging power to the power receiving unit only if the authentication server determines that the authentication number input by the user is a valid authentication number.

The authentication server may additionally include charging time in the result of the authentication.

The power transmitting unit may wirelessly supply the charging power only for the charging time.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a method of controlling permission for charging in a wireless charging system according to an embodiment of the present invention;

FIG. 2 is a diagram illustrating a PRU control message adopted in an embodiment of the present invention;

FIG. 3 is a diagram illustrating an “Authentication” field adopted in an embodiment of the present invention;

FIG. 4 is a diagram illustrating a “Permission” field adopted in an embodiment of the present invention;

FIG. 5 is a diagram illustrating dynamic parameter characteristics adopted in an embodiment of the present invention;

FIG. 6 is a diagram illustrating an “Authentication Number” field adopted in an embodiment of the present invention; and

FIG. 7 is a diagram showing a computer system in which an embodiment of the present invention has been implemented.

### DETAILED DESCRIPTION

The present invention may be modified in various ways and have various embodiments. Specific embodiments are illustrated in the drawings and described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and are not used to limit the present invention. A singular form may include a plural form unless otherwise defined. The terms, including “comprise,” “includes,” “comprising,” “including” and their derivatives, specify the presence of described shapes, numbers, steps, operations, elements, parts and/or groups thereof, and do not exclude the possibility of the presence or addition of one or more other shapes, numbers, steps, operations, elements, parts, and/or groups thereof.

Unless otherwise defined herein, all terms including technical or scientific terms used herein have the same meanings as commonly understood by those skilled in the art to which the present invention pertains. It will be further understood that terms, such as those defined in commonly used dictionaries, should be interpreted as having meanings that are consistent with their meanings in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference numerals are assigned to like components throughout the drawings and redundant descriptions of the like components are omitted.

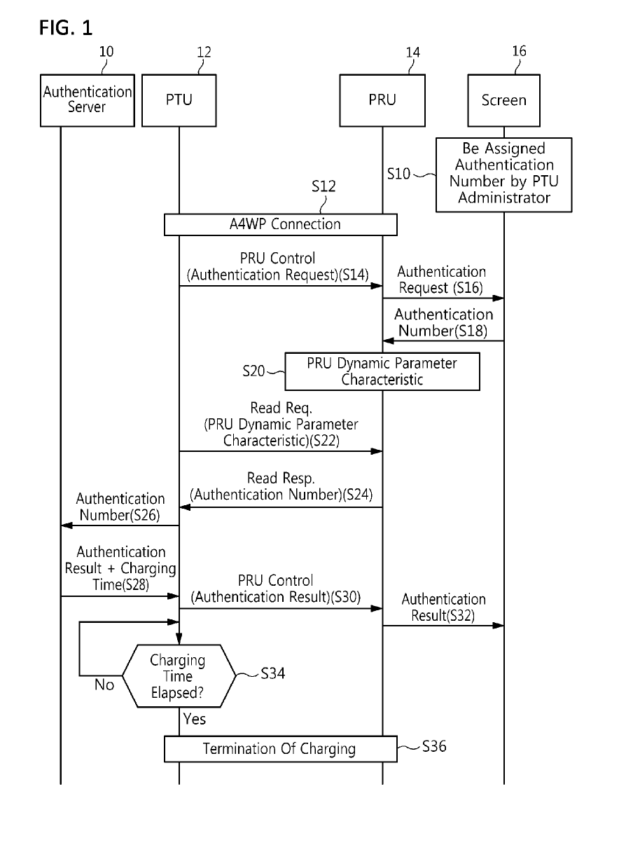

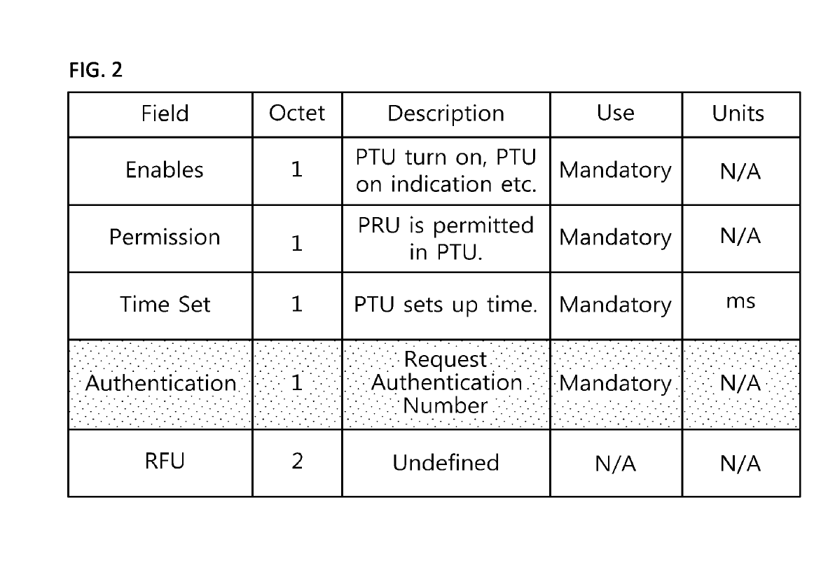

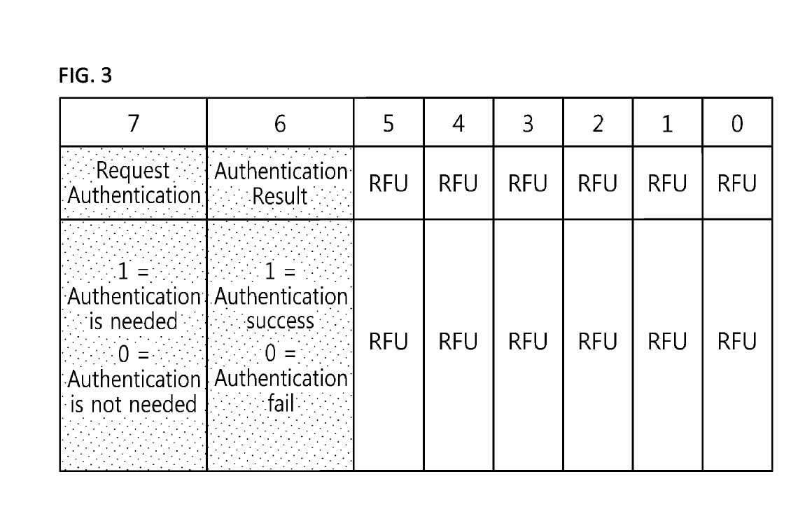

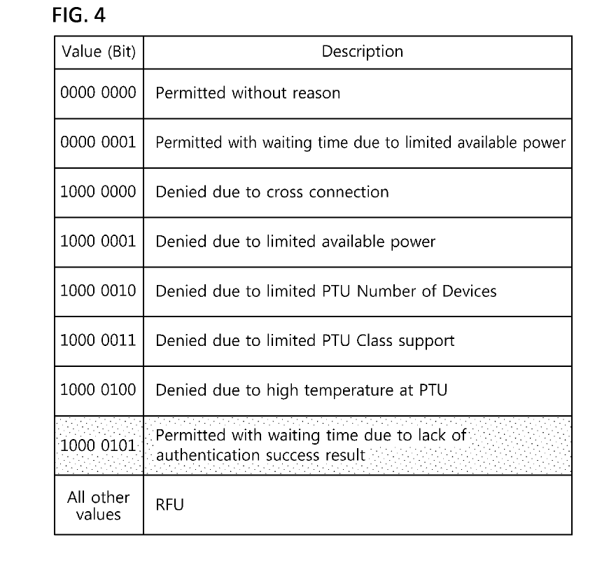

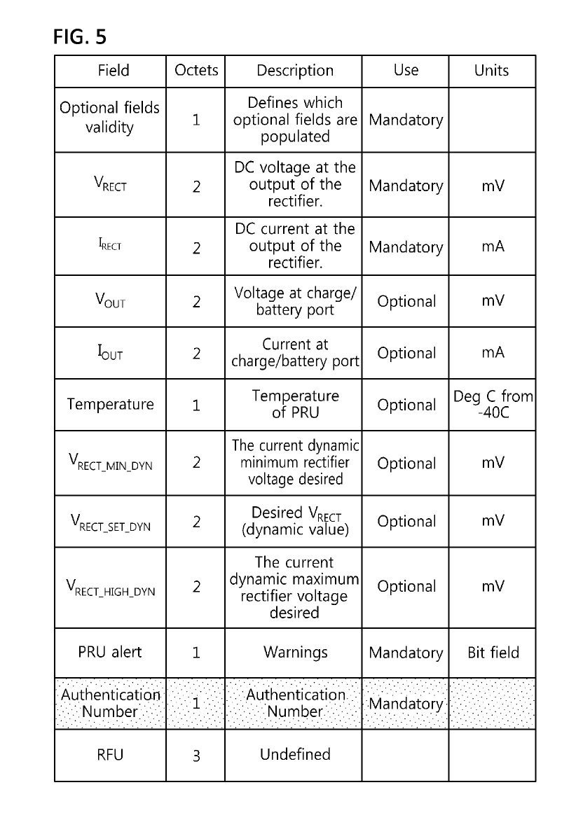

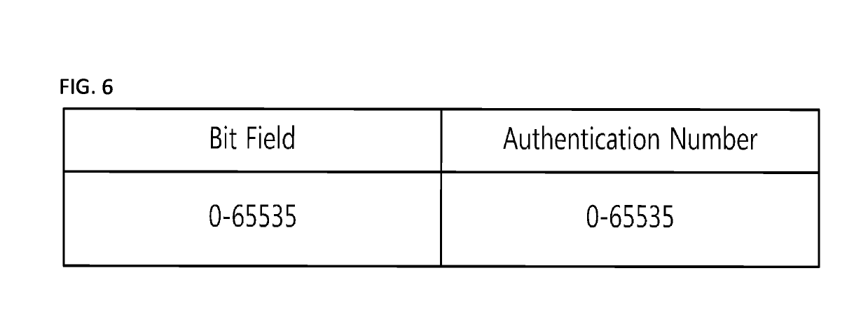

FIG. 1 is a flowchart showing a method of controlling permission for charging in a wireless charging system according to an embodiment of the present invention, FIG. 2 is a diagram illustrating a PRU control message adopted in an embodiment of the present invention, FIG. 3 is a diagram illustrating an “Authentication” field adopted in an embodiment of the present invention, FIG. 4 is a diagram illustrating a “Permission” field adopted in an embodiment of the present invention, FIG. 5 is a diagram illustrating dynamic parameter characteristics adopted in an embodiment of the present invention, and FIG. 6 is a diagram illustrating an “Authentication Number” field adopted in an embodiment of the present invention.

When a method of controlling permission for charging, which is described below, is performed by a wireless charging system complying with the A4WP standard, the wireless charging of a PRU may be permitted or denied based on whether a power provider has approved it based on the A4WP technology. Furthermore, the wireless charging system may include an authentication server 10 and a PTU 12, which will be described below.

First, a PRU user is assigned an authentication number by a PTU administrator at step S10. This step is not necessarily performed first. It is sufficient if this step is performed at the time at which the input of an authentication number by a user is required. This authentication number may be configured in the form of a number combination ranging from 0 to 65536.

Thereafter, the PRU user puts a PRU 14 in need of charging in a PTU charging area. Accordingly, the PTU 12 and the PRU 14 performs connection according to a method defined in the A4WP standard at step S12. In this case, the PTU 12 may be called a power transmitting unit, and the PRU 14 may be called a power receiving unit. It will be apparent that they are called a power transmitting unit and a power receiving unit, respectively.

Once the A4WP connection has been established between the PTU 12 and the PRU 14, the PTU 12 transmits a PRU control message, defined in the A4WP standard, to the PRU 14 at step S14. In this case, the PRU control message is illustrated in FIG. 2. In FIG. 2, an “Authentication” field value is a field value newly added according to an embodiment of the present invention. The detailed bit information of the newly added field is illustrated in FIG. 3. In FIG. 3, if a “Request Authentication” bit is “1,” this indicates that an authentication procedure based on an authentication number received from a PTU administrator is required. In contrast, if the corresponding bit is “0,” this indicates that the related authentication procedure is not required. If the corresponding bit is “0,” an operation is performed according to the A4WP standard, as in a conventional method.

Meanwhile, a “Permission” field in the PRU control message of FIG. 2 is changed as shown in FIG. 4. The definitions of the remaining field values are the same as those of the A4WP standard. Bits having the value “1000 0101” are newly added to the changed “Permission” field shown in FIG. 4. The bits having the value “1000 0101” indicate that since authentication has not been successfully performed, charging is not permitted immediately but will be permitted later only when authentication is successfully performed. For reference, the RFU illustrated in FIG. 4 refers to “reserved for further use.”

Thereafter, the PRU 14 having received the PRU control message notifies the user that an authentication number received from a PTU administrator is required to start charging via a screen 16 attached to the PRU 14 at step S16.

In response to this, the user inputs an authentication number via the screen 16 of the PRU 14. The input authentication number is provided to the PRU 14 at step S18. In this case, the authentication number is the authentication number that has been assigned by the PTU administrator at step S10.

After the PRU 14 has received the authentication number from the user, the PRU dynamic parameter characteristics defined in the A4WP standard are changed as shown in FIG. 5 at step S20. In FIG. 5, a newly added field is an “Authentication Number” field. The “Authentication Number” field contains the authentication number input by the PRU user. This authentication number may have a value ranging from 0 to 65535. FIG. 6 shows the detailed values of the “Authentication Number” field.

Furthermore, when the PRU 14 receives an input read request message from the PTU 12 at step S22, the PRU 14 transfers a read response message including updated PRU dynamic parameter characteristics to the PTU 12 at step S24.

Thereafter, the PTU 12 transfers the authentication number (which is included in the PRU dynamic parameter characteristics), received at the previous step, to the authentication server 10 at step S26. In this case, the authentication server 10 may be included in the PTU 12, or may be present outside the PTU 12 and connected over a network.

The authentication server 10 determines whether the authentication number is a valid authentication number. Only if the authentication number is a valid authentication number does the authentication server 10 transmit authentication success information to the PTU 12 at step S28. In this case, when the PTU administrator desires to control charging time, the PTU administrator may selectively and additionally include “charging time” in a response message and transfer the response message.

The PTU 12 updates the PRU control message based on the result of the authentication received from the authentication server 10, as shown in FIG. 2, and transfers this information to the PRU 14 according to a predetermined procedure at step S30. In this case, the authentication result value of the “Authentication” field is updated according to the result value received from the authentication server 10.

If the authentication result is failure, the following process is not performed and the overall process is terminated.

In contrast, if the authentication result is success, the following process is performed. That is, if the authentication result is success, the PRU 14 notifies the user of the authentication result, received from the PTU 12, via the screen 16 at step S32.

Furthermore, when the “charging time” is specified at the above-described step S28, the PTU 12 checks whether the charging time has elapsed at step S34, and terminates the charging process if the charging time has elapsed at step S36.

By doing so, when the A4WP wireless charging technology is used, the wireless charging of the PRU 14 is permitted or denied based on whether a power provider has approved it. That is, the power provider (the PTU administrator) assigns a normal authentication number to only a user to whom the power provider desires to permit wireless charging, and thus only the user to whom wireless charging has been performed may perform wireless charging.

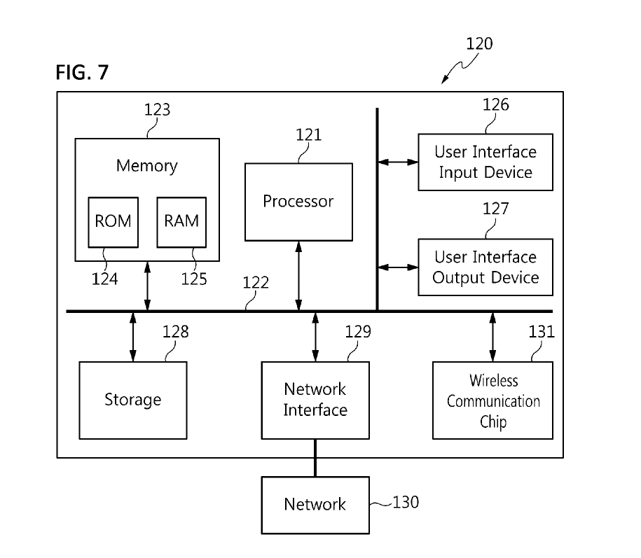

Meanwhile, the above-described embodiment of the present invention may be implemented in a computer system. As shown in FIG. 7, a computer system 120 may include at least one processor 121, memory 123, a user interface input device 126, a user interface output device 127, and storage 128, which communicate with each other over a bus 122. The computer system 120 may further include at least one network interface 129 connected to a network 130. The processor 121 may be a central processing unit or a semiconductor device that executes processing instructions stored in the memory 123 or storage 128. The memory 123 and the storage 128 may be various types of volatile or nonvolatile storage media. For example, the memory 123 may include ROM 124 or RAM 125.

Furthermore, in the case where the computer system 120 is implemented as a small-sized computing device in preparation for the Internet of Things (IoT) era, when an Ethernet cable is connected to the computing device, the computing device operates like a wireless sharer, a mobile device may be wirelessly connected to a gateway, and the computing device can perform encryption and decryption functions. For this purpose, the computer system 120 may further include a wireless communication chip (a WiFi chip) 131.

Accordingly, the embodiment of the present invention may be implemented as a non-transient computer-readable medium in which a computer implemented method or computer executable instructions have been stored. When computer-readable instructions are executed by a processor, the computer-readable instructions may perform a method according to at least one embodiment of the present invention.

According to the present invention configured as described above, when the A4WP wireless charging technology is used, the wireless charging of the PRU is permitted or denied based on whether a power provider has approved it.

As described above, the exemplary embodiments have been disclosed in the present specification and the accompanying drawings. Although the specific terms have been used herein, they have been used merely for the purpose of describing the present invention, but have not been used to restrict the meanings thereof or limit the scope of the present invention set forth in the attached claims. Accordingly, it will be appreciated by those having ordinary knowledge in the relevant technical field that various modifications and other equivalent embodiments can be made. Therefore, the true range of protection of the present invention should be defined based on the technical spirit of the attached claims.

What is claimed is:

1. A method of controlling permission for charging in a wireless charging system, comprising:
transmitting, by a power transmitting unit, a power receiving unit (PRU) control message to a power receiving unit;
receiving, by the power transmitting unit, PRU dynamic parameter characteristics generated by the power receiving unit based on an authentication number input by a user of the power receiving unit;
transmitting, by the power transmitting unit, the authentication number, input by the user and included in the PRU dynamic parameter characteristics, to an authentication server;
authenticating, by the authentication server, the authentication number input by the user; and
wirelessly supplying, by the power transmitting unit, charging power to the power receiving unit based on a result of the authentication of the authentication server.

2. The method of claim 1, wherein the PRU control message comprises an authentication field and a permission field.

3. The method of claim 2, wherein the authentication field, when a value of a request authentication bit within the authentication field is 1, indicates that an authentication number-based authentication procedure is required.

4. The method of claim 2, wherein the permission field contains bits indicating that since authentication has not been successfully performed, charging is not permitted immediately but will be permitted only when authentication is successfully performed later.

5. The method of claim 1, wherein transmitting the PRU control message is performed as a Alliance for Wireless Power (A4WP) connection is established between the power transmitting unit and the power receiving unit.

6. The method of claim 1, wherein:
the PRU dynamic parameter characteristics include an authentication number field indicative of the authentication number input by the user; and
the authentication number field contains a value ranging from 0 to 65535.

7. The method of claim 1, wherein wirelessly supplying the charging power to the power receiving unit comprises wirelessly supplying the charging power to the power receiving unit only if the authentication server determines that the authentication number input by the user is a valid authentication number.

8. The method of claim 1, further comprising, between authenticating the authentication number input by the user and wirelessly supplying the charging power to the power receiving unit:
transmitting, by the authentication server, a result of the authentication to the power transmitting unit.

9. The method of claim 8, wherein the result of the authentication additionally includes charging time.

10. The method of claim 9, wherein wirelessly supplying the charging power to the power receiving unit comprises wirelessly supplying the charging power only for the charging time.

11. A wireless charging system, comprising:
a power transmitting unit configured to transmit a power receiving unit (PRU) control message to a power receiving unit, to receive PRU dynamic parameter characteristics generated by the power receiving unit based on an authentication number input by a user of the power receiving unit, and to wirelessly supply charging power to the power receiving unit based on an input result of authentication; and
an authentication server configured to authenticate the authentication number input by the user and included in the PRU dynamic parameter characteristics provided by the power transmitting unit, and to transmit the result of the authentication to the power transmitting unit.

12. The wireless charging system of claim 11, wherein the PRU control message comprises an authentication field and a permission field.

13. The wireless charging system of claim 12, wherein the authentication field, when a value of a request authentication bit within the authentication field is 1, indicates that an authentication number-based authentication procedure is required.

14. The wireless charging system of claim 12, wherein the permission field contains bits indicating that since authentication has not been successfully performed, charging is not permitted immediately but will be permitted only when authentication is successfully performed later.

15. The wireless charging system of claim 11, wherein the power transmitting unit transmits the PRU control message as a Alliance for Wireless Power (A4WP) connection is established between the power transmitting unit and the power receiving unit.

16. The wireless charging system of claim 11, wherein:
the PRU dynamic parameter characteristics include an authentication number field indicative of the authentication number input by the user; and
the authentication number field contains a value ranging from 0 to 65535.

17. The wireless charging system of claim 11, wherein the power transmitting unit wirelessly supplies the charging power to the power receiving unit only if the authentication server determines that the authentication number input by the user is a valid authentication number.

18. The wireless charging system of claim 11, wherein the authentication server additionally includes charging time in the result of the authentication.

19. The wireless charging system of claim 18, wherein the power transmitting unit wirelessly supplies the charging power only for the charging time.
